(19) United States
(12) Patent Application Publication
(10) Pub. No.: US 2011/0251346 A1
(43) Pub. Date: Oct. 13, 2011

(54) Biodegradable Polymeric Compositions and Methods of Making and Using the Same

(75) Inventors: Fengkui Li, Houston, TX (US); John Ashbaugh, Houston, TX (US)

(73) Assignee: Fina Technology, Inc., Houston, TX (US)

(21) Appl. No.: 12/758,267

(22) Filed: Apr. 12, 2010

(51) Int. Cl. C08L 51/08; C08L 33/04

(52) U.S. Cl. 525/63; 525/222

(57) ABSTRACT

Biodegradable polymeric compositions and processes for making such are described herein. The processes generally include providing an olefin based polymer selected from polypropylene, polyethylene, combinations thereof and copolymers thereof and contacting the olefin based polymer with polylactic acid in the presence of a reactive modifier to form the biodegradable polymeric composition, wherein the reactive modifier is selected from oxazoline-grafted polyolefins, maleated polyolefin-based ionomers, isocyanate-functionalized polyolefins and combinations thereof.

### FIELD

Embodiments of the present invention generally relate to biodegradable polymeric materials.

### BACKGROUND

Synthetic polymeric materials, such as polypropylene and polyethylene resins, are widely used in the manufacturing of a variety of end-use articles ranging from medical devices to food containers. While articles constructed from synthetic polymeric materials have widespread utility, these materials tend to degrade slowly, if at all, in a natural environment. In response to environmental concerns, interest in the production and utility of more readily biodegradable polymeric materials has been increasing. These materials, also known as “green materials”, may undergo accelerated degradation in a natural environment. The utility of these biodegradable polymeric materials is often limited by their poor mechanical and/or physical properties. Thus, a need exists for biodegradable polymeric compositions having desirable physical and/or mechanical properties.

### SUMMARY

Embodiments of the present invention include a process for forming biodegradable polymeric compositions including providing an olefin based polymer selected from polypropylene, polyethylene, combinations thereof and copolymers thereof and contacting the olefin based polymer with polylactic acid in the presence of a reactive modifier to form the biodegradable polymeric composition, wherein the reactive modifier is selected from oxazoline-grafted polyolefins, maleated polyolefin-based ionomers, isocyanate-functionalized polyolefins and combinations thereof.

One or more embodiments include the process of the preceding paragraph, wherein the contact includes blending the olefin based polymer and the polylactic acid.

One or more embodiments include the process of any preceding paragraph, wherein the contact includes reactive extrusion.

One or more embodiments include the process of any preceding paragraph, wherein the contact includes forming a multi-layer film.

One or more embodiments include the process of any preceding paragraph, wherein the reactive modifier is formed by reactive extrusion.

One or more embodiments include the process of any preceding paragraph, wherein the reactive modifier is formed in the presence of an initiator.

One or more embodiments include the process of the preceding paragraph, wherein the reactive modifier is formed in the presence of a modifier.

One or more embodiments include the process of the preceding paragraph, wherein the modifier is selected from multi-functional acrylate comonomers, styrene, triacrylate esters and combinations thereof.

One or more embodiments include the a biodegradable polymeric composition including an olefin based polymer selected from polypropylene, polyethylene, combinations thereof and copolymers thereof, polylactic acid and a reactive modifier selected from oxazoline-grafted polyolefins, maleated polyolefin-based ionomers, isocyanate-functionalized polyolefins and combinations thereof.

One or more embodiments include the biodegradable polymeric composition of the preceding paragraph further including at least 50 wt. % olefin based polymer.

One or more embodiments include the biodegradable polymeric composition of any preceding paragraph further including from about 1 wt. % to about 49 wt. % polylactic acid.

One or more embodiments include the biodegradable polymeric composition of any preceding paragraph further including from about 0.5 wt. % to about 15 wt. % reactive modifier.

One or more embodiments include the biodegradable polymeric composition of any preceding paragraph, wherein the reactive modifier is formed in the presence of an initiator and a modifier.

One or more embodiments include the biodegradable polymeric composition of any preceding paragraph, wherein the modifier is selected from multi-functional acrylate comonomers, styrene, triacrylate esters and combinations thereof.

One or more embodiments include the biodegradable polymeric composition of the preceding paragraph, wherein the reactive modifier composition includes from about 0.5 wt. % to about 15 wt. % modifier.

One or more embodiments include the biodegradable polymeric composition of any preceding paragraph, wherein a ratio of grafting component to modifier ranges from about 1:5 to about 10:1.

One or more embodiments include the biodegradable polymeric composition of any preceding paragraph, wherein the reactive modifier exhibits a grafting yield of from about 0.2 wt. % to about 15 wt. %.

One or more embodiments include a process for forming biodegradable polymeric compositions including providing an olefin based polymer selected from polypropylene, polyethylene, combinations thereof and copolymers thereof, forming a reactive modifier in the presence of an initiator and a modifier; the modifier adapted to increase grafting yield of the reactive modifier compared to an identical process absent the modifier and contacting the olefin based polymer with polylactic acid in the presence of the reactive modifier to form the biodegradable polymeric composition, wherein the reactive modifier is selected from oxazoline-grafted polyolefins, maleated polyolefin-based ionomers, isocyanate-functionalized polyolefins and combinations thereof.

### BRIEF DESCRIPTION OF DRAWINGS

FIG. 1 illustrates torque processing parameters for a variety of polymer samples.

FIG. 2 illustrates Fourier Transform Infrared Spectroscopy (FTIR) of PP and PP-g-NCO.

FIG. 3 illustrates DSC Tg of PLA phases in PP/PLA blends.

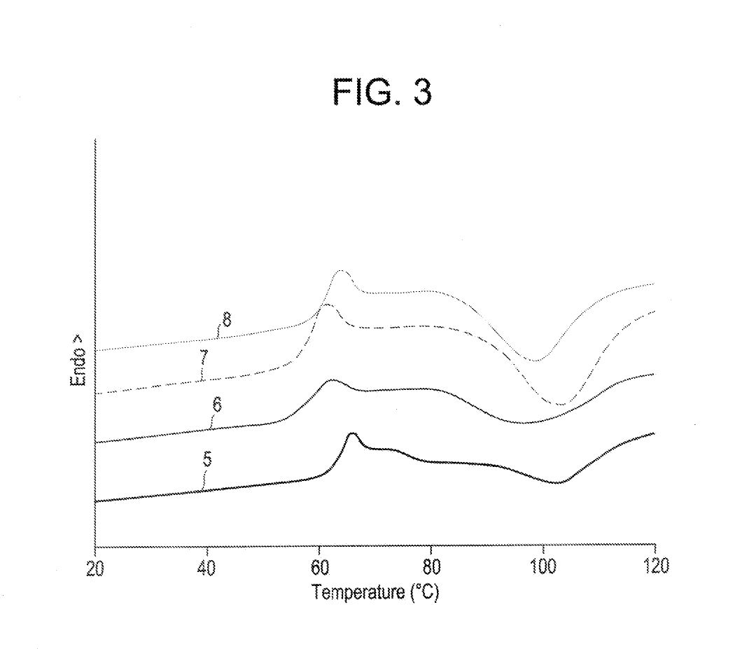

FIG. 4 illustrates DSC Tg of PLA phases in maleated PP/PLA/metal compound blends.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only; In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

Biodegradable polymeric compositions and methods of making and using the same are described herein. The biodegradable polymeric compositions are formed of an olefin based polymer, polylactic acid and a reactive modifier.

The biodegradable polymeric compositions are generally materials capable of at least partial breakdown. For example, the biodegradable polymeric compositions may be broken down by the action of living things.

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

As indicated elsewhere herein, the catalyst systems are used to form olefin based polymer compositions (which may be interchangeably referred to herein as polyolefins). Once the catalyst system is prepared, as described above and/or as known to one skilled in the art, a variety of processes may be carried out using that composition to form olefin based polymers. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form olefin based polymers. The olefin monomers may include C₂ to C₃₀ olefin monomers, or C₂ to C₁₂ olefin monomers (e.g., ethylene, propylene, butene, pentene 4-methyl-1-pentene, hexene, octene and decene), for example. It is further contemplated that the monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzycyclobutane, styrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat may be removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. Upon removal from the reactor, the olefin based polymer may be passed to a polymer recovery system for further processing, such as addition of additives and/or extrusion, for example.

The olefin based polymers formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of tiling. In one or more embodiments, the olefin based polymers include propylene based polymers. As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

The propylene based polymers may have a molecular weight distribution (Mₙ/M_{w}) of from about 1.0 to about 20, or from about 1.5 to about 15 or from about 2 to about 12, for example.

The propylene based polymers may have a melting point (Tₘ) (as measured by DSC) of at least about 110° C., or from about 115° C. to about 175° C., for example.

The propylene based polymers may include about 15 wt. % or less, or about 12 wt. % or less 12, or about 10 wt. % or less, or about 6 wt. % or less, or about 5 wt. % or less or about 4 wt. % or less of xylene soluble material (XS), for example (as measured by ASTM D5492-06).

The propylene based polymers may have a melt flow rate (MFR) (as measured by ASTM D-1238) of from about 0.01 dg/min to about 1000 dg/min., or from about 0.01 dg/min. to about 100 dg/min., for example.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

The ethylene based polymers may have a density (as measured by ASTM D-792) of from about 0.86 g/cc to about 0.98 g/cc, or from about 0.88 g/cc to about 0.965 Wee, or from about 0.90 g/cc to about 0.965 g/cc or from about 0.925 g/cc to about 0.97 g/cc, for example.

The ethylene based polymers may have a melt index (MI₂) (as measured by ASTM D-1238) of from about 0.01 dg/min to about 100 dg/min., or from about 0.01 dg/min. to about 25 dg/min., or from about 0.03 dg/min. to about 15 dg/min. or from about 0.05 dg/min. to about 10 dg/min, for example.

In one or more embodiments, the olefin based polymers include low density polyethylene. In one or more embodiments, the olefin based polymers include linear low density polyethylene. In one or more embodiments, the olefin based polymers include medium density polyethylene. As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the olefin based polymers include high density polyethylene. As used herein, the term “high density polyethylene” refers to ethylene based polymers having a density of from about 0.94 g/cc to about 0.97 g/cc, for example.

The olefin based polymers are contacted with polylactic acid (PLA) to form the biodegradable polymeric compositions (which may also be referred to herein as a blend or blended material). Such contact may occur by a variety of methods. For example, such contact may include blending of the olefin based polymer and the polylactic acid under conditions suitable for the formation of a blended material. Such blending may include dry blending, extrusion, mixing or combinations thereof, for example.

Alternatively, such contact may include utilizing a multi-layer film to form the biodegradable polymeric composition. The multi-layer film may include a polyolefin layer and a PLA layer. The polyolefin layer and the PLA layer may be tied by a layer disposed between the polyolefin layer and the PLA layer (i.e., a tie layer). The tie layer may be formed of the reactive modifier.

The biodegradable polymeric composition may include at least 50 wt. %, or from about 51 wt. % to about 99 wt. %, or from about 70 wt. % to about 95 wt. % or from about 80 wt. % to about 90 wt. % olefin based polymer based on the total weight of the biodegradable polymeric composition, for example.

The polylactic acid may include any polylactic acid capable of blending with an olefin based polymer. For example, the polylactic acid may be selected from poly-L-lactide (PLLA), poly-D-lactide (PDLA), poly-LD-lactide (PDLLA) and combinations thereof. The polylactic acid may be formed by known methods, such as dehydration condensation of lactic acid (see, U.S. Pat. No. 5,310,865, which is incorporated by reference herein) or synthesis of a cyclic lactide from lactic acid followed by ring opening polymerization of the cyclic lactide (see, U.S. Pat. No. 2,758,987, which is incorporated by reference herein), for example. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

The polylactic acid may have a density of from about 1.238 g/cc to about 1.265 g/cc, or from about 1.24 g/cc to about 1.26 g/cc or from about 1.245 g/cc to about 1.255 g/cc (as determined in accordance with ASTM D792), for example.

The polylactic acid may exhibit a melt index (210° C., 2.16 kg) of from about 5 g/10 min. to about 35 g/10 min., or from about 10 g/10 min. to about 30 g/10 min. or from about 10 g/10 min. to about 20 g/10 min (as determined in accordance with ASTM D1238), for example.

The polylactic acid may exhibit a crystalline melt temperature (Tₘ) of from about 150° C. to about 180° C., or from about 160° C. to about 175° C. or from about 160° C. to about 170° C. (as determined in accordance with ASTM D3418), for example.

The polylactic acid may exhibit a glass transition temperature of from about 45° C. to about 85° C., or from about 50° C. to about 80° C. or from about 55° C. to about 75° C. (as determined in accordance with ASTM D3417), for example.

The polylactic acid may exhibit a tensile yield strength of from about 4,000 psi to about 25,000 psi, or from about 5,000 psi to about 20,000 psi or from about 5,500 psi to about 20,000 psi (as determined in accordance with ASTM D638), for example.

The polylactic acid may exhibit a tensile elongation of from about 1.5% to about 10%, or from about 2% to about 8% or from about 3% to about 7% (as determined in accordance with ASTM D638), for example.

The polylactic acid may exhibit a flexural modulus of from about 250,000 psi to about 600,000 psi, or from about 300,000 psi to about 550,000 psi or from about 400,000 psi to about 500,000 psi (as determined in accordance with ASTM D790), for example.

The polylactic acid may exhibit a notched Izod impact of from about 0.1 ft-lb/in to about 0.8 ft-lb/in, or from about 0.2 ft-lb/in to about 0.7 ft-lb/in or from about 0.4 ft-lb/in to 0.6 about ft-lb/in (as determined in accordance with ASTM D256), for example.

The biodegradable polymeric composition may include from about 1 wt. % to about 49 wt. %, or from about 5 wt. % to about 30 wt. % or from about 10 wt. % to about 20 wt. % polylactic acid based on the total weight of the biodegradable polymeric composition, for example.

In one or more embodiments, the biodegradable polymeric composition further includes a reactive modifier. The reactive modifier may be incorporated into the biodegradable polymeric composition via a variety of methods. For example, the olefin based polymer and the polylactic acid may be contacted with one another in the presence of the reactive modifier. As used herein, the term “reactive modifier” refers to polymeric additives that, when added to a molten blend of immiscible polymers (e.g., the olefin based polymer and the PLA), form compounds in situ that serve to stabilize the blend. The compounds formed in situ compatibilize the blend and the reactive modifiers are precursors to these compatibilizers.

In one or more embodiments, the reactive modifier is selected from oxazoline-grafted polyolefins, maleated polyolefin-based ionomers; isocyanate (NCO)-functionalized polyolefins and combinations thereof, for example. The oxazoline-grafted polyolefin is a polyolefin grafted with an oxazoline ring-containing monomer. In one or more embodiments, the oxazoline may include a 2-oxazoline, such as 2-vinyl-2-oxazoline (e.g., 2-isopropenyl-2-oxazoline), 2-fatty-alkyl-2-oxazoline (e.g., those obtainable from the ethanolamide of oleic acid, linoleic acid, palmitoleic acid, gadoleic acid, erucic acid and/or arachidonic acid) and combinations thereof, for example. In yet another embodiment, the oxazoline may be selected from ricinoloxazoline maleinate, undecyl-2-oxazoline, soya-2-oxazoline, ricinus-2-oxazoline and combinations thereof, for example. In yet another embodiment, the oxazoline is selected from 2-isopropenyl-2-oxazoline, 2-isopropenyl-4,4-dimethyl-2-oxazoline and combinations thereof, for example. The oxazoline-grafted polyolefin may include from about 0.1 wt. % to about 10 wt. % or from 0.2 wt. % to about 2 wt. % oxazoline, for example.

The isocyanate (NCO)-functionalized polyolefins include a polyolefin grafted with an isocyanate functional monomer. The isocyanate may be selected from TMI® unsaturated isocyanate (meta), meta and para-isopropenyl-alpha, alpha-dimethylbenzyl isocyanate; meta-isopropenyl-alpha, alpha-dimethylbenzyl isocyanate; para-isopropenyl-alpha, alpha-dimethylbenzyl isocyanate and combinations thereof, for example.

The maleated polyolefin-based ionomers include a polyolefin ionomer maleated and then neutralized with a metal component. Maleation is a type of grafting wherein maleic anhydride, acrylic acid derivatives or combinations thereof are grafted onto the backbone chain of a polymer. The metal component may be selected from sodium hydroxide, calcium oxide, sodium carbonate, sodium hydrogencarbonate, sodium methoxide, sodium acetate, magnesium ethoxide, zinc acetate, diethylzine, aluminium butoxide, zirconium butoxide and combinations thereof, for example. In one specific embodiment, the metal component is selected from sodium hydroxide, zinc acetate and combinations thereof, for example.

In one or more embodiments, the graftable polymer is a polyolefin is selected from polypropylene, polyethylene, combinations thereof and copolymers thereof.

The reactive modifiers may be prepared by any suitable method. For example, the reactive modifiers may be formed by a grafting reaction. The grafting reaction may occur in a molten state inside of an extruder, for example (e.g., “reactive extrusion”). Such grafting reaction may occur by feeding the feedstock sequentially along the extruder or the feedstock may be pre-mixed and then fed into the extruder, for example.

In one or more embodiments, the reactive modifiers are formed by grafting in the presence of an initiator, such as peroxide. Examples of initiators may include LUPERSOL® 101 and TRIGANOX® 301, commercially available from Arkema, Inc., for example.

The initiator may be used in an amount of from about 0.01 wt. % to about 2 wt. % or from about 0.2 wt. % to about 0.8 wt. % or from about 0.3 wt. % to about 0.5 wt. % based on the total weight of the reactive modifier, for example.

Alternatively, the reactive modifiers may be formed by grafting in the presence of an initiator, such as those described above, and a modifier selected from multi-functional acrylate comonomers, styrene, triacrylate esters and combinations thereof, for example. The multi-functional acrylate comonomer may be selected from polyethylene glycol diacrylate, trimethylolpropanc triacrylate (TMPTA), alkoxylated hexanediol diacrylatete and combinations thereof, for example. The triacrylate esters may include trimethylopropane triacrylate esters, for example. It has unexpectedly been observed that the modifiers described herein are capable of improving grafting compared to processes absent such comonomers.

In one or more embodiments, the reactive modifier may include from about 80 wt. % to about 99.5 wt. %, or from about 90 wt. % to about 99 wt. % or from about 95 wt. % to about 99 wt. % polyolefin based on the total weight of the reactive modifier, for example.

In one or more embodiments, the reactive modifier may include from about 0.5 wt. % to about 20 wt. %, or from about 1 wt. % to about 10 wt. % or from about 1 wt. % to about 5 wt. % grafting component the oxazoline, isocyanate, maleic anhydride, acrylic acid derivative) based on the total weight of the reactive modifier, for example.

In one or more embodiments, the reactive modifier may include from about 0.5 wt. % to about 15 wt. %, or from about 1 wt. % to about 10 wt. % or from about 1 wt. % to about 5 wt. % modifier on the total weight of the reactive modifier, for example.

The ratio of grafting component to modifier may vary from about 1:5 to about 10:1, or from about 1:2 to about 5:1 or from about 1:1 to about 3:1, for example.

In one or more embodiments, the reactive modifier may exhibit a grafting yield of from about 0.2 wt. % to about 20 wt. %, or from about 0.5 wt. % to about 10 wt. % or from about 1 wt. % to about 5 wt. %, for example. The grafting yield may be determined by Fourier Transform Infrared Spectroscopy (FTIR) spectroscopy.

The biodegradable polymeric composition may include from about 0.5 wt. % to about 20 wt. %, or from about 1 wt. % to about 10 wt. % or from about 3 wt. % to about 5 wt. % reactive modifier based on the total weight of the biodegradable polymeric composition, for example.

In an embodiment, the biodegradable polymeric composition, the olefin based polymer, the polylactic acid, the reactive modifier or combinations thereof may contain additives to impart desired physical properties, such as printability, increased gloss, or a reduced blocking tendency. Examples of additives may include, without limitation, stabilizers, ultra-violet screening agents, oxidants, anti-oxidants, anti-static agents, ultraviolet light absorbents, fire retardants, processing oils, mold release agents, coloring agents, pigments/dyes, fillers or combinations thereof, for example. These additives may be included in amounts effective to impart desired properties.

The biodegradable polymeric composition may exhibit a melt flow rate of from about 0.5 g/10 min. to about 500 g/10 min., or from about 1.5 g/10 min. to about 50 g/10 min. or from about 5.0 g/10 min. to about 20 g/10 min, for example. (MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.)

The biodegradable polymeric compositions are useful in applications known to one skilled in the art to be useful for conventional polymeric compositions, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, mono filaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

### EXAMPLES

### Example 1

### Production and Characterization of PP-g-NCO

A polypropylene homopolymer (2.8 g/10 min melt flow rate) was melt grafted with NCO groups using TMI unsaturated isocyanate monomer supplied by Cytec Industries Inc and peroxide Lupersol® 101 on a Haake internal mixer. The mixer temperature was set at 220° C. and rotor speed at 60 rpm for 4 minutes. Sample 1 in Table 1 is pure polypropylene. Sample 2 is polypropylene and TMI monomer plus peroxide. Sample 3 is similar to sample 2 but with addition of small amount of SR 259 Polyethylene glycol (200) diacrylate supplied from Sartomer Inc. Sample 4 is similar to sample 2 but without TMI monomer.

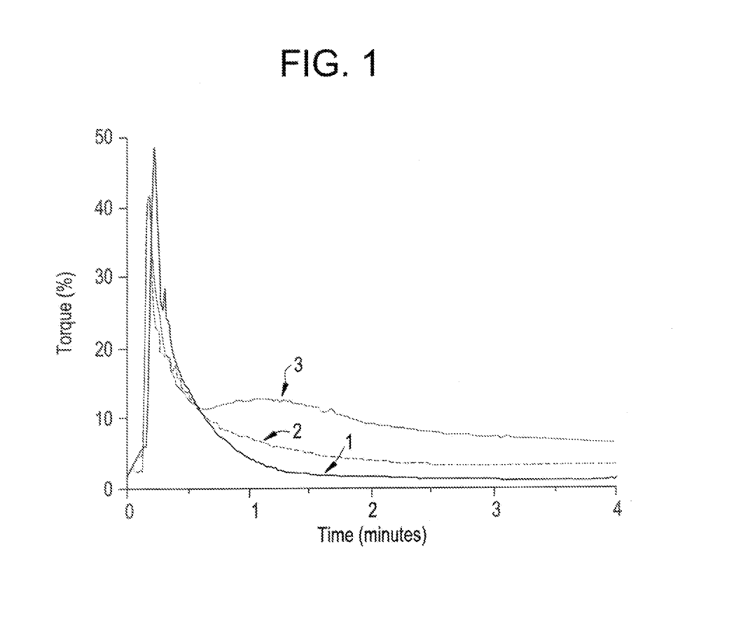

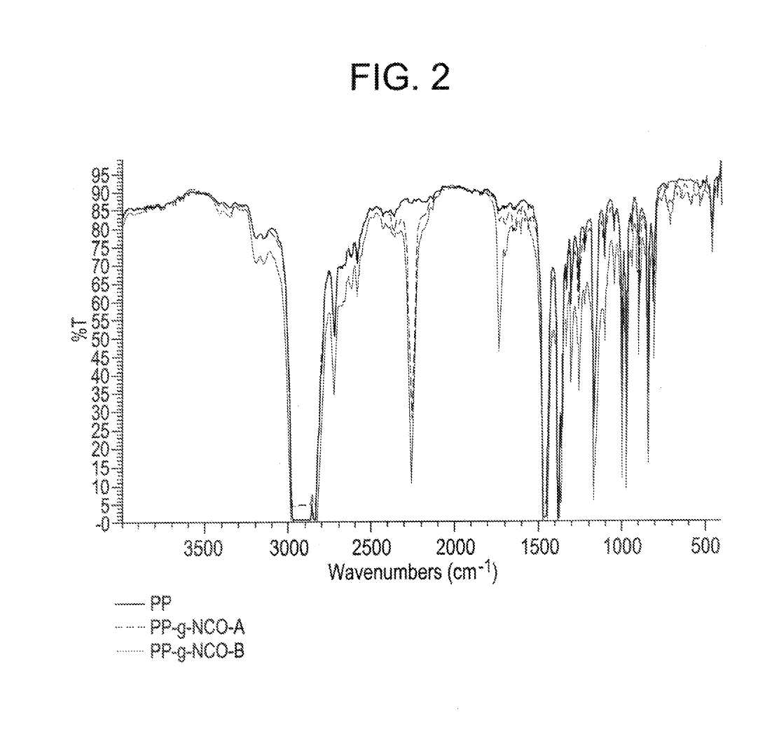

The processing torque results of the grafting process are shown in FIG. 1. The products were compressed into 0.5 mil thick films and vacuum dried at 80° C. for 12 hours to remove unreacted monomers and volatiles prior to FTIR characterization. FTIR spectra of the PP-g-NCO products are shown in FIG. 2. IR absorption at 2250 cm−1 is attributed to NCO-groups and that of 900 cm−1 attributed to polypropylene. Thus, IR absorption ratio of 2250 cm−1 to 900 cm−1 peaks is essentially correlated to grafting yield of PP-g-NCO materials. Apparently, NCO-groups could be effectively grafted onto polypropylene chains, and presence of diacrylate SR259 boosted the NCO grafting yields.

TABLE 1

| Samples | 3371 (g) | TMI | SR259 | Lupersol 101 | NCO Grafting |
|---|---|---|---|---|---|
| 1 | 50 | 0.0 | 0.0 | 0.0 | 0.04 |
| 2 | 50 | 2.5 | 0.0 | 0.25 | 2.78 |
| 3 | 50 | 2.5 | 1.0 | 0.25 | 3.00 |
| 4 | 50 | 0.0 | 1.0 | 0.25 | 0.04 |

### Example 2

### Making and Characterization of PP-g-NCO blends with PLA

The materials produced in Example 1 were further blended with equivalent amounts of PLA 3251 supplied by NatureWorks Inc. on the Haake internal mixer under the same mixing conditions as in Example 1. Detailed formulations are shown in Table 2. White and opaque materials were obtained. The materials were run for DSC and PLA phase glass transition temperatures (Tg) were characterized.

Presence of NCO groups shifted PLA Tg to lower temperatures toward that of polypropylene, indicating that the blends become more compatible. It is expected that NCO groups are very easy to react with PLA during melt processing, forming PP-g-PLA copolymers acting as compatibilizers between polypropylene and PLA phases, resulting in compatibilized PP/PLA blends.

TABLE 2

| Samples | PP materials (g) | PLA 3251 (g) | DSC Tg for PLA (° C.) |
|---|---|---|---|
| 5 | 25 g sample 1 | 25 | 59.9 |
| 6 | 25 g sample 2 | 25 | 54.5 |
| 7 | 25 g sample 3 | 25 | 55.1 |
| 8 | 25 g sample 4 | 25 | 58.3 |

### Example 3

### PP/PLA Ionomer Materials

Maleated polypropylene Polybond 3150 supplied from Chemtura was melt blended with 50% PLA 3251 supplied by NatureWorks LLC and/or small amounts of different metal compounds. The mixer temperature was set at 210° C. and rotor speed at 60 rpm for 4 minutes. Sample 9 in Table 9 is the simple blend of maleated PP and PLA as the control. Sample 10 involves maleated PP/PLA blends with zinc stearate (ZnSt). Sample 11 is similar to sample 10 but with addition of small amount of zinc acetate (ZnAc) instead. Sample 12 is similar to sample 11 but with potassium hydroxide (KOH) instead. The materials were characterized for DSC.

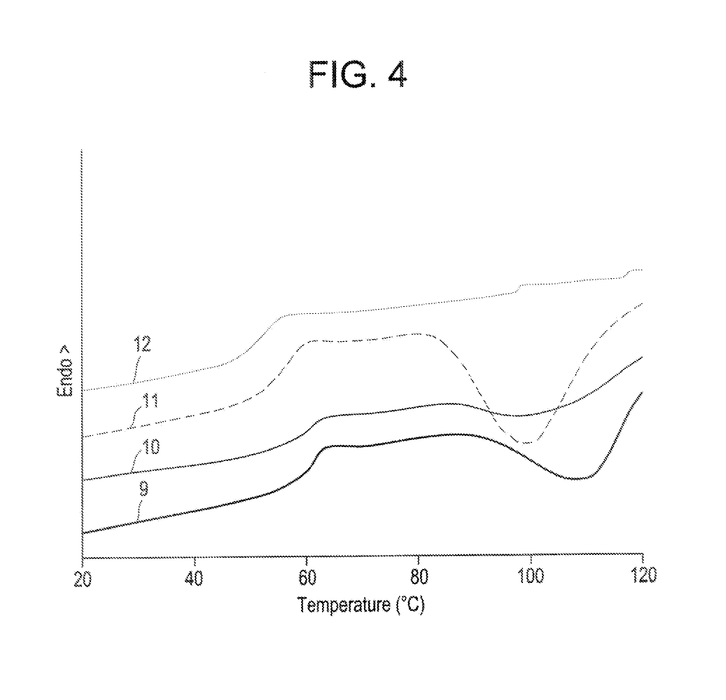

FIG. 4 shows that PLA glass transition temperature (Tg) was lowered by the presence of ZnAc and KOH, indicating that ionic interactions effectively compatibilized between PP and PLA phases in the blends.

TABLE 3

| | Maleated PP | PLA 3251 | 2% metal | DSC Tg for PLA |
|---|---|---|---|---|
| Samples | (g) | (g) | compound | (° C.) |
| 9 | 25 | 25 | | 58.2 |
| 10 | 25 | 25 | ZnSt | 58.7 |
| 11 | 25 | 25 | ZnAc | 55.3 |
| 12 | 25 | 25 | KOH | 49.9 |

While the foregoing is directed to embodiments of the present invention, other and further embodiments of the invention may be devised without departing from the basic scope thereof and the scope thereof is determined by the claims that follow.

What is claimed is:

1. A process for forming biodegradable polymeric compositions comprising:
providing an olefin based polymer selected from polypropylene, polyethylene, combinations thereof and copolymers thereof; and
contacting the olefin based polymer with polylactic acid in the presence of a reactive modifier to form the biodegradable polymeric composition, wherein the reactive modifier is selected from oxazoline-grafted polyolefins, maleated polyolefin-based ionomers, isocyanate-functionalized polyolefins and combinations thereof.

2. The process of claim 1, wherein the contact comprises blending the olefin based polymer and the polylactic acid.

3. The process of claim 1, wherein the contact comprises reactive extrusion.

4. The process of claim 1, wherein the contact comprises forming a multi-layer film.

5. The process of claim 1, wherein the reactive modifier is formed by reactive extrusion.

6. The process of claim 5, wherein the reactive modifier is formed in the presence of an initiator.

7. The process of claim 6, wherein the reactive modifier is formed in the presence of a modifier.

8. The process of claim 7, wherein the modifier is selected from multi-functional acrylate comonomers, styrene, triacrylate esters and combinations thereof.

9. A biodegradable polymeric composition comprising:
an olefin based polymer selected from polypropylene, polyethylene, combinations thereof and copolymers thereof;
polylactic acid; and
a reactive modifier selected from oxazoline-grafted polyolefins, maleated polyolefin-based ionomers, isocyanate-functionalized polyolefins and combinations thereof.

10. The composition of claim 9 further comprising at least 50 wt. % olefin based polymer.

11. The composition of claim 9 further comprising from about 1 wt. % to about 49 wt. % polylactic acid.

12. The composition of claim 9 further comprising from about 0.5 wt. % to about 15 wt. % reactive modifier.

13. The composition of claim 9, wherein the reactive modifier is formed in the presence of an initiator and a modifier.

14. The process of claim 13, wherein the modifier is selected from multi-functional acrylate comonomers, styrene, triacrylate esters and combinations thereof.

15. The process of claim 13, wherein the reactive modifier composition comprises from about 0.5 wt. % to about 15 wt. % modifier.

16. The process of claim 13, wherein a ratio of grafting component to modifier ranges from about 1:5 to about 10:1.

17. The process of claim 13, wherein the reactive modifier exhibits a grafting yield of from about 0.2 wt. % to about 15 wt. %.

18. A process for forming biodegradable polymeric compositions comprising:
providing an olefin based polymer selected from polypropylene, polyethylene, combinations thereof and copolymers thereof;
forming a reactive modifier in the presence of an initiator and a modifier, the modifier adapted to increase grafting yield of the reactive modifier compared to an identical process absent the modifier; and
contacting the olefin based polymer with polylactic acid in the presence of the reactive modifier to form the biodegradable polymeric composition, wherein the reactive modifier is selected from oxazoline-grafted polyolefins, maleated polyolefin-based ionomers, isocyanate-functionalized polyolefins and combinations thereof.
